(19) United States
(12) Patent Application Publication
(10) Pub. No.: US 2026/0038505 A1
(43) Pub. Date: Feb. 5, 2026

(54) INFORMATION PROCESSING SYSTEM, INFORMATION PROCESSING METHOD, AND PROGRAM

(71) Applicant: NTT TechnoCross Corporation, Tokyo (JP)

(72) Inventors: Chaeha OH, Tokyo (JP); Hiroshi YOKOI, Tokyo (JP); Hosana KAMIYAMA, Tokyo (JP)

(73) Assignee: NTT TechnoCross Corporation, Tokyo (JP)

(21) Appl. No.: 18/995,730

(22) PCT Filed: Jul. 21, 2022
(86) PCT No.: PCT/JP2022/028380

§ 371 Date: Jan. 16, 2025

(51) Int. Cl. G10L 15/32; G10L 15/183; G10L 15/22; G10L 15/30

(52) U.S. Cl. CPC G10L 15/32; G10L 15/183; G10L 15/22; G10L 15/30

(57) ABSTRACT

An information processing system includes:
a selection part configured to select a speech recognition dictionary for use in speech recognition from among a plurality of speech recognition dictionaries; and
a speech recognition part configured to generate speech recognition text by converting voices uttered during a voice call with a customer, into text, by speech recognition using the speech recognition dictionary selected by the selection part.

In this information processing system, when a switchover to a different speech recognition dictionary selected is made by the selection part, the speech recognition part is configured to generate speech recognition text by converting voices uttered before the switchover is made, among the voices uttered during the voice call with the customer, into text, by speech recognition using the different speech recognition dictionary.

### TECHNICAL FIELD

The present disclosure relates to an information processing system, an information processing method, and a program.

### BACKGROUND ART

Speech recognition technology generally uses speech recognition dictionaries, in which the spelling, pronunciation, arrangement, and so forth of words are shown. Various types of speech recognition dictionaries are used depending on the intended purpose of use of speech recognition, the language dealt with in speech recognition, and so forth. For example, there may be a dictionary for general-purpose use, a dictionary that contains many technical terms related to a specific field of business/technology, a dictionary specialized in a specific language, a dictionary specialized in a specific dialect, and so forth.

Nowadays, in a contact center (also referred to as a “call center”), a speech recognition system that implements the above-mentioned speech recognition technology is used so as to convert the voices in a voice call into text, and present the text to the operator on a real-time basis (see, for example, non-patent document 1).

### CITATION LIST

### Non-Patent Documents

Non-Patent Document 1: ForeSight Voice Mining, Internet URL: www.ntt-tx.co.jp/products/foresight_vm/

### SUMMARY OF INVENTION

### Technical Problem

However, if multiple speech recognition dictionaries are available for use, an operator may have difficulty selecting an appropriate dictionary from among them. Consequently, speech recognition may be carried out simply by using a speech recognition dictionary that is set for the operator in advance (for example, a default general-purpose speech recognition dictionary). This, however, might result in a case where speech recognition yields outcomes that are not sufficiently accurate.

The present disclosure has been made in view of the foregoing, and aims to provide a technique whereby accurate outcomes of speech recognition can be obtained.

### Solution to Problem

One example of the present disclosure provides an information processing system that includes:
a selection part configured to select a speech recognition dictionary for use in speech recognition from among a plurality of speech recognition dictionaries; and
a speech recognition part configured to generate speech recognition text by converting voices uttered during a voice call with a customer, into text, by speech recognition using the speech recognition dictionary selected by the selection part.

In this information processing system, when a switchover to a different speech recognition dictionary selected by the selection part is made, the speech recognition part is configured to generate speech recognition text by converting voices uttered before the switchover is made, among the voices uttered during the voice call with the customer, into text, by speech recognition using the different speech recognition dictionary.

### Advantageous Effects of Invention

The present disclosure provides a technique whereby accurate outcomes of speech recognition can be obtained.

### BRIEF DESCRIPTION OF THE DRAWINGS

FIG. 1 is a diagram that shows an example overall structure of a contact center system according to an embodiment of the present disclosure;

FIG. 2 shows an example functional structure of a contact center system according to an embodiment of the present disclosure;

FIG. 3 is a sequence diagram that shows an example service assisting process according to an embodiment of the present disclosure;

FIG. 4 is a diagram (first diagram) for explaining an example of speech recognition;

FIG. 5 is a diagram (second diagram) for explaining an example of speech recognition;

FIG. 6 is a diagram (third diagram) for explaining an example of speech recognition;

FIG. 7 is a diagram (fourth diagram) for explaining an example of speech recognition;

FIG. 8 is a diagram (fifth diagram) for explaining an example of speech recognition;

FIG. 9 is a diagram (first diagram) for explaining an example service assisting screen; and

FIG. 10 is a second diagram for explaining an example service assisting screen.

### DETAILED DESCRIPTION OF THE PREFERRED EMBODIMENTS

An embodiment of the present disclosure will be described now. In the following description, a contact center system 1 will be mainly described. The following description will take a place at a contact center, and, when a dictionary is selected automatically or manually from among multiple speech recognition dictionaries, the contact center system 1 makes it possible to obtain accurate outcomes of speech recognition from the voices of a voice call held between an operator and a customer. However, a contact center is just one example, and the present disclosure may be likewise applied to, for example, a case in which, in an office or a similar environment where a dictionary can be selected from among multiple speech recognition dictionaries so as to obtain maximally accurate outcomes of speech recognition from the voices in a voice call that is held between a service representative and a customer.

### Overall Structure of Contact Center System 1

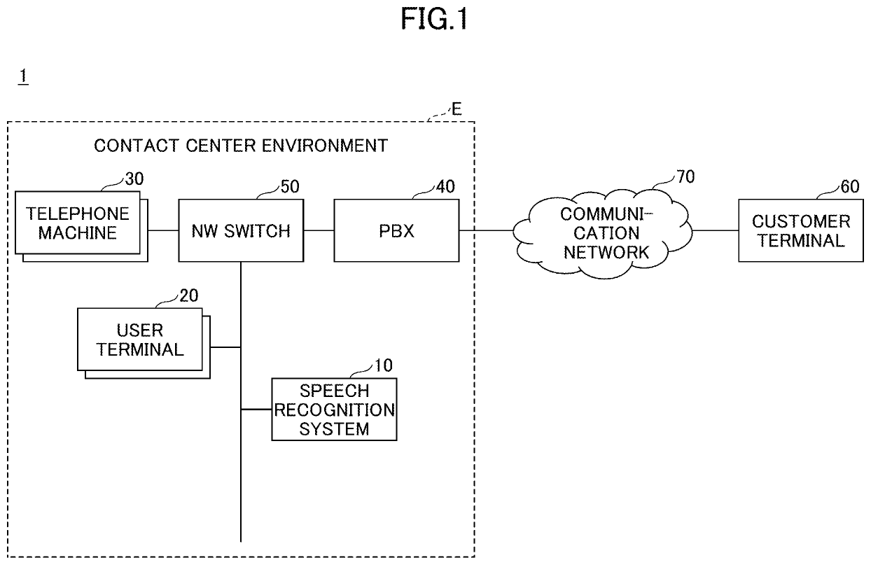

FIG. 1 shows an example overall structure of the contact center system 1 according to the present embodiment. As shown in FIG. 1, the contact center system 1 according to the present embodiment includes a speech recognition system 10, multiple user terminals 20, multiple telephone machines 30, a private branch exchange (PBX) 40, a network (NW) switch 50, and a customer terminal 60. The speech recognition system 10, user terminals 20, telephone machines 30, PBX 40, and NW switch 50 are installed inside a contact center environment E, which is the contact center's system environment. Note that the contact center environment E is by no means limited to being a system environment in the same building, and may be, for example, a system environment that spans multiple buildings that are geographically separate.

For example, the speech recognition system 10 uses packets (voice packets) sent from the NW switch 50 to record, in a voice file, the voices in a voice call held between an operator and a customer. Note that the speech recognition system 10 may receive voice packets from the NW switch 50 in a passive manner. On the other hand, the speech recognition system 10 may send a request for voice data to the PBX 40 via the NW switch 50 and thus receive the voice data in an active manner.

Also, the speech recognition system 10 applies speech recognition to this voice file and generates text that represents an outcome of this speech recognition (hereinafter referred to as “speech-recognized voice,” “speech-recognized voice file,” “speech-recognized text,” “speech recognition voice,” “speech recognition text,” etc.). Then, if the speech recognition dictionary that is in use is switched or changed, the speech recognition system 10, using the post-change speech recognition dictionary performs speech recognition again on the voice files that have already been speech-recognized (that is, speech recognition is executed again on voices that have been speech-recognized using the old speech recognition dictionary used before the change of the dictionary. of the dictionary. For example, assuming that speech recognition is executed on voices using an inappropriate speech recognition dictionary and then the dictionary is changed, the above technique then makes it possible to obtain accurate outcomes of speech recognition, for example, by applying speech recognition to the voices again by using an appropriate speech recognition dictionary that is used after the change of the dictionary. Note that the speech recognition system 10 is implemented, for example, by a general-purpose server or a group of servers.

A user terminal 20 may refer to a variety of terminals such as a personal computer (PC) that an operator or a supervisor can use. Note that the time “a user” as used herein primarily refers to an operator. A user may be a supervisor as well. Note that an operator is a person whose main job is to answer voice calls to customers. Note that a supervisor refers to, for example, a person who monitors operators' voice calls and assists the operators in performing their telephone answering duties when a problem is likely to arise, or upon request from the operators. Normally, voice calls by several operators to several tens of operators are monitored by one supervisor.

The user terminal 20 displays a service assisting screen, on which the speech recognition outcomes (speech recognition text) of a voice call with a customer are shown visually. By looking at this service assisting screen, the operator can also check the content of the voice call with the customer in the form of text.

A telephone machine 30 is an Internet protocol (IP) telephone machine (a fixed IP telephone machine, a portable IP telephone machine, etc.) for an operator's use.

The PBX 40 is a private branch exchange (IP-PBX) that is connected to a communication network 70, which may be a voice over Internet protocol (VoIP) network, a public switched telephone network (PSTN), or the like.

The NW switch 50 relays packets between the telephone machine 30 and the PBX 40, captures the packets, and sends them to the speech recognition system 10.

A customer terminal 60 may be a variety of terminals that a customer can use, such as a smartphone, a mobile phone, a landline telephone, and so forth.

Note that the overall structure of the contact center system 1 shown in FIG. 1 is only an example, and other structures may be employed as well. For example, in the example shown in FIG. 1, the speech recognition system 10 is included in the contact center environment E (that is, the speech recognition system 10 is an on-premise type). However, some or all of the functions of the speech recognition system 10 may be implemented by, for example, a cloud service or the like. Similarly, referring again to the example shown in FIG. 1, the PBX 40 is an on-premise telephone exchange, but it may also be implemented by a cloud service. Also, if the user terminal 20 functions as a telephone machine, the contact center system 1 need not include telephone machines 30.

### Functional Structure of Contact Center System 1

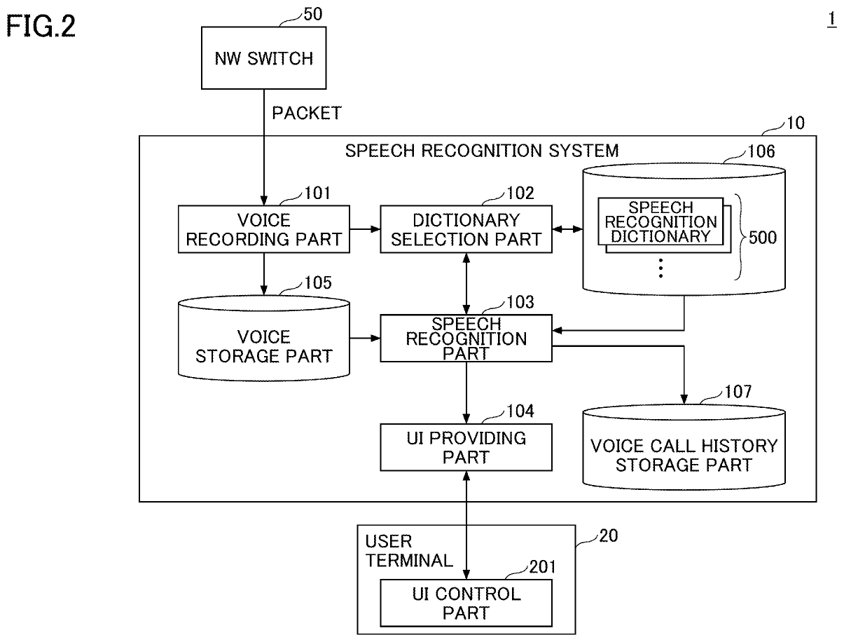

FIG. 2 shows an example functional structure of the speech recognition system 10 and a user terminal 20 included in the contact center system 1 according to an embodiment of the present disclosure.

### Speech Recognition System 10

As shown in FIG. 2, the speech recognition system 10 according to an embodiment of the present disclosure includes a voice recording part 101, a dictionary selection part 102, a speech recognition part 103, and a UI providing part 104. These parts are implemented, for example, by processes executed by one or more programs installed in the speech recognition system 10 and run on a processor such as a central processing unit (CPU). Also, the speech recognition system 10 according to an embodiment of the present disclosure includes a voice storage part 105, a dictionary storage part 106, and a voice call history storage part 107. These parts can be implemented by, for example, a storage device such as a hard disk drive (HDD), a solid state drive (SSD), and so forth. Note that at least part of the storage fields of these parts may be implemented by, for example, a storage device or the like (for example, a database server) that is communicably connected to the speech recognition system 10.

The voice recording part 101 stores the voice data represented by a packet (voice packet) transmitted from the NW switch 50 in the voice storage part 105 as a voice file.

The dictionary selection part 102 selects the speech recognition dictionary 500 to use in speech recognition, from multiple among speech recognition dictionaries 500 stored in the dictionary storage part 106. A speech recognition dictionary 500 refers to dictionary information that shows, for example, the spelling of words, their pronunciation, arrangement, and so forth. There are various types of speech recognition dictionaries 500, including: a general-purpose speech recognition dictionary; a speech recognition dictionary specialized for a specific field of business/technology (for example, finance, insurance, data communications, etc.); a speech recognition dictionary specialized for a specific language (for example, Japanese, English, French, etc.), and a speech recognition dictionary specialized for a specific dialect (for example, a dialect spoken in a certain region of Japan, etc.). Hereinafter, the speech recognition dictionary 500 selected by the dictionary selection part 102 will also be referred to as the “currently-selected dictionary 500.”

The speech recognition part 103 applies speech recognition to the voice files stored in the voice storage part 105 using the currently-selected dictionary 500, which is selected by the dictionary selection part 102, and generates speech recognition text, which is the outcome of speech recognition. In doing so, the speech recognition part 103 performs speech recognition on the voice of each speaker (operator, customer, etc.) and generates speech recognition text with speaker information and time information. The speech recognition text of a certain duration of speech (such as a voiced segment, a voiced phrase, etc.) is expressed in the form or combination of, for example, “speaker information, time information, and speech recognition text.” This speech recognition text with speaker information and time information can be generated using existing speech recognition technology. Note that the speaker information refers to information about the speaker (operator or customer) who uttered the speech corresponding to the speech recognition text, and its time information indicates the time (date and time) the speech corresponding to the speech recognition text was uttered. In the following description, speech recognition text is accompanied by speaker information and time information and is expressed in the form or combination of, for example: “(speaker information, time information, and speech recognition text).”

Also, if the currently-selected dictionary 500 is changed, the speech recognition part 103 performs speech recognition again on a voice file that has already been speech-recognized, using the post-change dictionary 500.

Furthermore, when a voice call held between an operator and a customer is completed, for example, the speech recognition part 103 stores voice call history information, including speech recognition text relating to the voice call, in the voice call history storage part 107.

The UI providing part 104 provides screen information for a service assisting screen, on which the speech recognition text generated by the speech recognition part 103 is visualized. Note that the screen information is expressed using information such as, for example, HTML (Hypertext Markup Language), CSS (Cascading Style Sheets), JavaScript, etc.

The voice storage part 105 stores voice files, in which the voices of packets (voice packets) transmitted from the NW switch 50 are stored.

The dictionary storage part 106 stores multiple speech recognition dictionaries 500. Among these speech recognition dictionaries 500, a speech recognition dictionary 500 is selected as a default dictionary (or as a standard dictionary) (hereinafter referred to as the “default dictionary 500”). The speech recognition dictionary 500 is usually a general-purpose speech recognition dictionary. For example, if a contact center mainly deals with questions about a specific business or service, a speech recognition dictionary specialized for that business or service may be set as the default dictionary 500. For example, if a contact center mainly handles questions from customers that speak a specific language, the default dictionary 500 may be a speech recognition dictionary specialized for that language. If a contact center mainly answers questions from customers that live in a particular region, its default dictionary 500 may be a speech recognition dictionary specialized for that region's dialect.

The voice call history storage part 107 stores voice call history information. The voice call history information is information, including, for example, at least the call ID and the speech recognition text of the voice call associated with that call ID. The voice call history information may include various information such as, for example, the date and time of the voice call, the duration of the voice call, the ID of the operator who answered the voice call, the operator's extension number, the customer's telephone number, any notes about the voice call, etc.

### User Terminal 20

As shown in FIG. 2, a user terminal 20 according to an embodiment of the present disclosure has a UI control part 201. The UI control part 201 is implemented by a process executed by one or more programs (web browser, etc.) installed in the user terminal 20, for example, by a processor such as a CPU.

The UI control part 201 displays various screens including a service assisting screen on the display of the user terminal 20. Also, the UI control part 201 accepts various input operations of the user on these various screens.

### Service Assisting Process

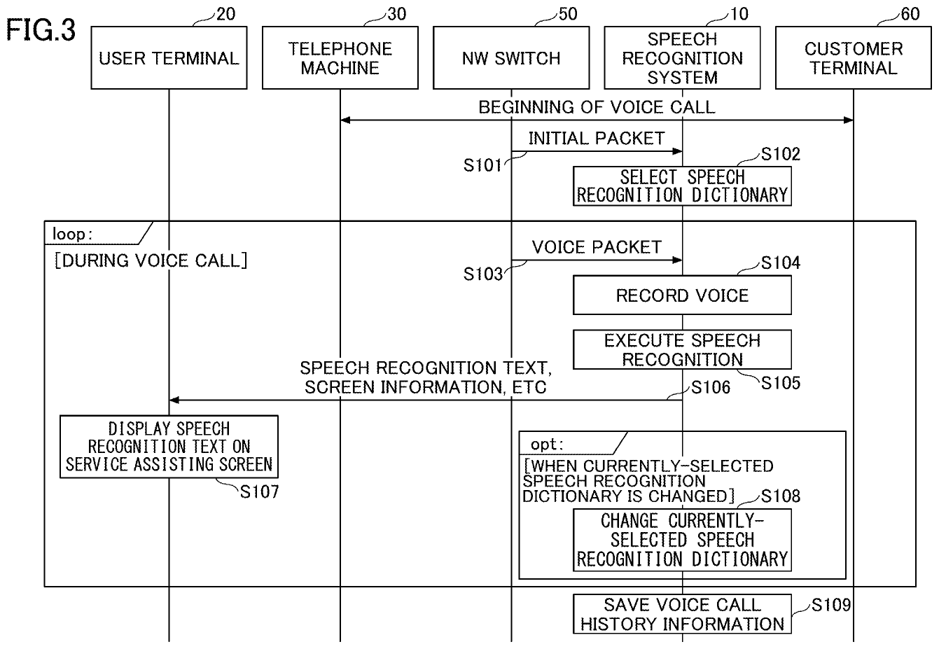

Below, with reference to FIG. 3, the process of performing speech recognition on voices during a voice call between an operator and a customer and displaying the outcome of speech recognition on the service assisting screen of the user terminal 20 (service assisting process) will be described.

When a voice call is started between an operator and a customer, the voice recording part 101 of the speech recognition system 10 receives a beginning packet indicating that the voice call has started (Step S101).

Next, the dictionary selection part 102 of the speech recognition system 10 selects the speech recognition dictionary 500 to be used in speech recognition from among the multiple speech recognition dictionaries 500 stored in the dictionary storage part 106 (step S102). Here, the dictionary selection part 102 may, for example, select the default dictionary 500, the dictionary selection part 102 may also make an inquiry to the user terminal 20 as to which speech recognition dictionary 500 is to be used, and then select the speech recognition dictionary 500 specified by the user (operator) in response to the inquiry. Also, when asking which speech recognition dictionary 500 the user terminal 20 is to use, the dictionary selection part 102 may give the user (operator) a certain grace period of, for example, several tens of seconds. If no speech recognition dictionary 500 is specified within this grace period, the default dictionary 500 may be selected (in this case, speech recognition will not be performed until the grace period is over). This is because it is generally difficult for the operator to determine which speech recognition dictionary 500 to is to be used, at the beginning of a voice call. Alternatively, for example, it is possible to only consider that the default dictionary 500 is selected, until another speech recognition dictionary 500 is explicitly specified by the operator.

The following steps S103 to S108 are repeated while the operator and the customer talk over the telephone.

The voice recording part 101 of the speech recognition system 10 receives a packet (voice packet) transmitted from the NW switch 50 (step S103).

Next, the voice recording part 101 of the speech recognition system 10 stores the voice data represented by the packet as a voice file in the voice storage part 105 (step S104).

Next, the speech recognition part 103 of the speech recognition system 10 applies speech recognition to the voice file stored in the voice storage part 105 using the currently-selected dictionary 500, and generates speech recognition text, which is the outcome of the speech recognition (Step S105). At this time, if the currently-selected dictionary 500 is changed in step S108, which will be described later, the speech recognition part 103 performs speech recognition again on the voice file that has already been speech-recognized, using the post-change dictionary 500. Note that the details of speech recognition in this step will be described later.

Next, the UI providing part 104 of the speech recognition system 10 transmits the speech recognition text generated in step S105 above, with screen information for visualizing the speech recognition text, to the user terminal 20 (for example, the user terminal 20 that the operator making the voice call is using) (step S106). Here, the UI providing part 104 may transmit the speech recognition text and screen information to the user terminal 20 every time speech recognition text is generated in step S105 above. The UI providing part 104 may also transmit the speech recognition text and screen information to the user terminal 20 in response to a request from the user terminal 20. Note that the UI providing part 104 may transmit the speech recognition text and screen information not only to the user terminal 20 that the operator making the voice call is using, but also, for example, to the user terminal 20 that the supervisor monitoring the operator's voice call is using.

When the UI control part 201 of the user terminal 20 receives the speech recognition text and the screen information, it displays the speech recognition text on the service assisting screen based on the screen information (step S107). Note that the service assisting screen in this step will be explained in greater detail later.

When changing the currently-selected dictionary 500, the dictionary selection part 102 of the speech recognition system 10 changes the currently-selected dictionary 500 to one of the multiple speech recognition dictionaries 500 (step S108). Here, when, for example, the user (operator) designates a specific speech recognition dictionary 500, the dictionary selection part 102 changes the currently-selected dictionary 500 to that speech recognition dictionary 500. This is because after a voice call has been going on for a certain period of time, the operator should be able to determine which speech recognition dictionary 500 is suitable for use.

However, this is by no means a limitation, and the dictionary selection part 102 may determine whether or not to change the currently-selected dictionary 500 based on some kind of decision logic, and may also determine which speech recognition dictionary 500 is suitable for use. For example, the dictionary selection part 102 may specify what language is being spoken, by using existing natural language processing, and then change the currently-selected dictionary 500 to a speech recognition dictionary 500 specialized for the specified language. Similarly, for example, the dictionary selection part 102 may identify the dialect of the customer, by using existing natural language processing, and then change the currently-selected dictionary 500 to a speech recognition dictionary 500 specialized for the identified dialect. Also, for example, the dictionary selection part 102 may use an existing technique of inference such as machine learning to infer the business or service content from the frequency of specific words contained in earlier speech recognition text and so forth (for example, speech recognition outcome obtained by using the default dictionary 500, which is a general-purpose speech recognition dictionary 500), and then change the currently-selected dictionary 500 to a speech recognition dictionary 500 specialized for that business or service.

When the voice call between the operator and the customer is terminated, the speech recognition part 103 of the speech recognition system 10 creates voice call history information including speech recognition text related to the voice call, and stores the voice call history information in the voice call history storage part 107 (step S109). Note that voice call history information is used, for example, for various analyses to improve the quality of service to customers and for evaluating operators.

### Details of Speech Recognition in Step S105 of FIG. 3

The speech recognition in step S105 in FIG. 3 will be described in detail below. In the following description, assume that the default dictionary 500 was selected in step S102 in FIG. 3.

### First Example of Speech Recognition: When the Currently-Selected Dictionary 500 is Not Changed

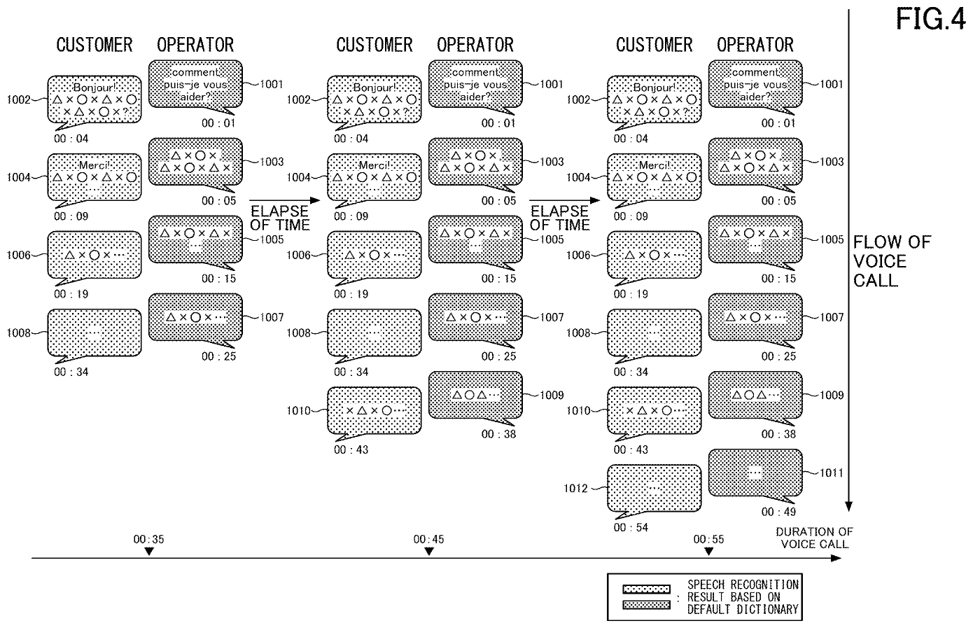

As shown in FIG. 4, assume that the speech recognition text of the voices 1001 to 1008 by the time “00:35” during the voice call is obtained by speech recognition using the default dictionary 500. Note that the voices 1001, 1003, 1005, and 1007 are uttered by the operator, and the voices 1002, 1004, 1006, and 1008 are uttered by the customer.

In this case, according to this example of speech recognition, the currently-selected dictionary 500 is not changed, so that the speech recognition text of the operator's voice 1009 by the time “00:38” in the voice call and the speech recognition text of the customer's voice 1010 by the time “00:43” in the voice call are both obtained by speech recognition using the default dictionary 500.

Similarly, the speech recognition text of the operator's voice 1011 by the time “00:49” in the voice call and the speech recognition text of the customer's voice 1012 by the time “00:54” in the voice call are both obtained by speech recognition using the default dictionary 500.

In this way, if the currently-selected dictionary 500 is not changed, the currently-selected dictionary 500 will be used for the voices (utterances) during the voice call is recognized.

### Second Example of Speech Recognition: When the Currently-Selected Dictionary 500 is Changed

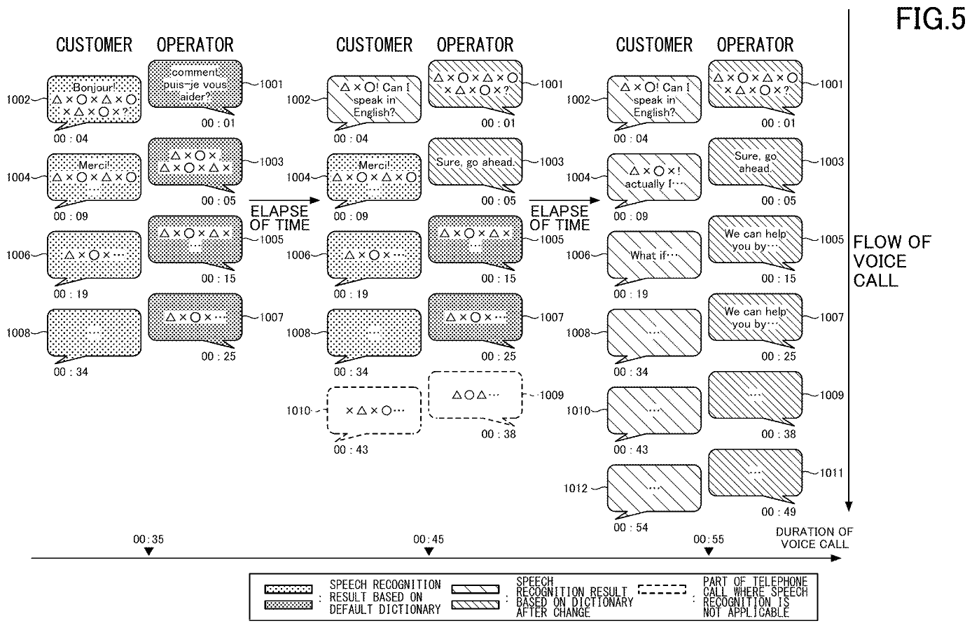

As shown in FIG. 5, assume that the speech recognition text of the voices 1001 to 1008 by the time “00:35” during the voice call is obtained by speech recognition using the default dictionary 500. Note that the voices 1001, 1003, 1005, and 1007 are uttered by the operator, and the voices 1002, 1004, 1006, and 1008 are uttered by the customer.

In this case, assume that the currently-selected dictionary 500 is changed at or after “00:35,” and before “00:38,” during the voice call. In this case, according to this example of speech recognition, the voices 1001 to 1008 that have been speech-recognized earlier are subjected to speech recognition, in chronological order, using the post-change dictionary 500. On the other hand, the voices 1009 to 1012 after the currently-selected dictionary 500 is changed are subjected to speech recognition, in chronological order, after the speech recognition of the voices 1001 to 1008 is completed.

In the example shown in FIG. 5, the speech recognition text of the voices 1001 to 1003 is obtained by the time “00:45” during the voice call, by speech recognition using the post-change dictionary 500. Also, the speech recognition text for the voices 1001 to 1012 is obtained by the time “00:55” during the voice call, by speech recognition using the post-change dictionary 500.

In this way, when the currently-selected dictionary 500 is changed, according to this example of speech recognition, the voices uttered before the change of the dictionary 500 are subjected to speech recognition again, in chronological order, using the post-change dictionary 500, and then the voices uttered after the change of the dictionary 500 are subjected to speech recognition, in chronological order, using the post-change dictionary 500. Hereinafter, voices uttered by the operator and the customer before the currently-selected dictionary 500 is changed will be referred to as “past voices,” and voices uttered by the operator and the customer after the currently-selected dictionary 500 is changed will be referred to as “real-time voices.” Also, a voice file containing voices uttered in the past will also be referred to as a “past voice file”, and a voice file containing voices uttered in real time will also be referred to as a “real-time voice file.” Note that, if voices uttered in the past and voices uttered in real time are recorded in the same voice file, the past voice file and the real-time voice file may be the same voice file. However, voices uttered in the past and voices uttered in real time may be recorded in different voice files. This makes a past voice file and a real-time voice file different voice files.

### Third Example of Speech Recognition: When the Currently-Selected Dictionary 500 is Changed and Past Voice Files are Processed in Parallel Per Voiced Segment

In the second example of speech recognition described above, the dictionary 500 after change of the dictionary 500 is used to execute speech recognition on past voices again, in chronological order. This is because, in general speech recognition processing, speech recognition needs to be performed starting from the beginning of each voice file. On the other hand, by performing a process called “voiced segment detection” (also referred to as “voice activity detection (VAD)”) on a voice file, it is possible to execute speech recognition on individual voiced segment units in parallel. Therefore, according to this example of speech recognition, voiced segment detection is first performed on a past voice file, and then speech recognition is executed on individual past voiced segment units in parallel. However, the number of processing units that can be subjected to speech recognition in parallel (hereinafter referred to as “the number of units to be processed in parallel”) depends on the number of speech recognition engines and the like, and is basically a predetermined number.

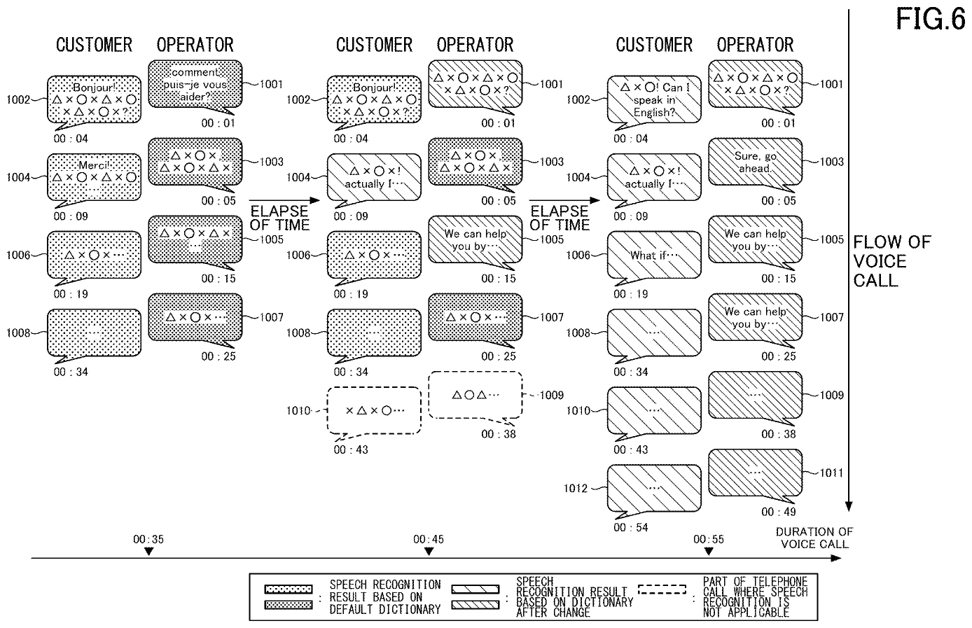

As shown in FIG. 6, assume that, by the time “00:35” during the voice call, the speech recognition text of the voices 1001 to 1008 is obtained by speech recognition using the default dictionary 500. Note that the voices 1001, 1003, 1005, and 1007 are uttered by the operator, and the voices 1002, 1004, 1006, and 1008 are uttered by the customer.

In this case, assume that the currently-selected dictionary 500 is changed at or after “00:35,” and before “00:38,” during the voice call. In this case, according to this example of speech recognition, the voices 1001 to 1008 that have been speech-recognized earlier are subjected to speech recognition again, in parallel, using the post-change dictionary 500. On the other hand, the voices 1009 to 1012 after the currently-selected dictionary 500 is changed are subjected to speech recognition, in chronological order, after the speech recognition of the voices 1001 to 1008 is completed.

In the example shown in FIG. 6, the speech recognition text for the voices 1001 and voices 1004 to 1005 is obtained by the time “00:45” during the voice call, from speech recognition using the post-change dictionary 500. In this example, the number of units to be processed in parallel is 2, and the voice 1001 and the voices 1004 to 1005 are subjected to speech recognition in parallel. Also, the speech recognition text for the voices 1001 to 1012 is obtained by the time “00:45” during the voice call, from speech recognition using the post-change dictionary 500.

In this way, when the currently-selected dictionary 500 is changed, according to this example of speech recognition, the voices uttered before the change of the dictionary 500 are subjected to speech recognition again, in parallel, using the post-change dictionary 500, and then the voices uttered after the change of the dictionary 500 are subjected to speech recognition, in chronological order, using the post-change dictionary 500. This allows, for example, speech recognition to be applied to past voices preferentially. For example, it becomes possible to give priority to speech recognition of past voices that are close to the actual time and voices that are close to the beginning of the voice call. Also, speech recognition can be executed on past voices in parallel, it is possible to complete speech recognition of past voices more quickly.

Note that, in this example of speech recognition, speech recognition is executed on individual voiced segment units by detecting voiced segments by using a process called “voice activity detection.” However, this is just one example. For example, it is also possible to detect sentences, phrases, and so on, and execute speech recognition, in parallel, on individual sentences, phrases, and so forth.

### Fourth Example of Speech Recognition: When the Currently-Selected Dictionary 500 is Changed and Past Voice Files and Real-Time Voice Files are Processed in Parallel

In the second example of speech recognition described above, speech recognition is executed on all past voices by using the post-change dictionary 500, and then executed on real-time voices using the post-change dictionary 500. On the other hand, by recording past voices and real-time voices in different voice files, it is possible to subject past voices and real-time voices to speech recognition in parallel. Therefore, according to this example of speech recognition, past voices and real-time voices are recorded in different voice files, and past voices and real-time voices are subjected to speech recognition in parallel.

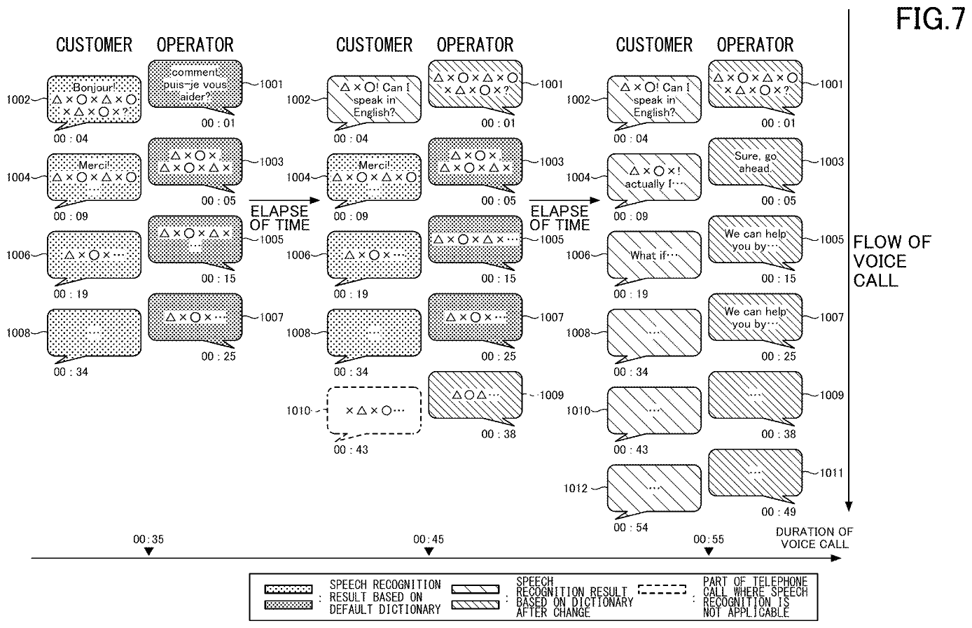

As shown in FIG. 7, assume that the speech recognition text of the voices 1001 to 1008 is obtained by the time “00:35” during the voice call by speech recognition using the default dictionary 500. Note that the voices 1001, 1003, 1005 and 1007 are uttered by the operator, and the voices 1002, 1004, 1006, and 1008 are uttered by the customer.

In this case, assume that the currently-selected dictionary 500 is changed at or after “00:35,” and before “00:38,” during the voice call. In this example of speech recognition, using the post-change dictionary 500, the voices 1001 to 1008 that have been speech-recognized earlier are subjected to speech recognition again in chronological order, and the voices 1009 to 1012 are also subjected to speech recognition in chronological order. That is, past voices and real-time voices are subjected to speech recognition in parallel, and in chronological order.

In the example shown in FIG. 7, the speech recognition text for the voices 1001 and 1002 and the voice 1009 is obtained by the time “00:45” during the voice call, by speech recognition using the post-change dictionary 500. In this example, the voices 1001 and 1002, which are past voices, and the voice 1009, which is a real-time voice, are subjected to speech recognition in parallel. Also, the speech recognition text for the voices 1001 to 1012 is obtained, by the time “00:45” during the voice call, from speech recognition using the post-change dictionary 500.

In this way, when the currently-selected dictionary 500 is changed, according to this example of speech recognition, the voices uttered before the change of the dictionary 500 and the voices uttered after the change of the dictionary 500 are subjected to speech recognition in parallel, and in chronological order, using the post-change dictionary 500. This makes it possible to execute speech recognition on real-time voices while processing past voices at the same time.

### Fifth Example of Speech Recognition: When the Currently-Selected Dictionary 500 is Changed, Past Voice Files are Processed in Parallel on a Per Voiced Segment Basis, and Past Voice Files and Real-Time Voice Files are Processed in Parallel

This example of speech recognition combines the third and fourth examples of speech recognition described earlier. In other words, according to this example of speech recognition, past voices and real-time voices are recorded in different voice files, and voice activity detection is performed on the past voice file. Subsequently, the past voices and real-time voices are subjected to speech recognition in parallel, and the past voices are also subjected to speech recognition, in parallel. However, how many past voice units can be processed in parallel depends on the number of speech recognition engines, and the like, and is usually a predetermined number.

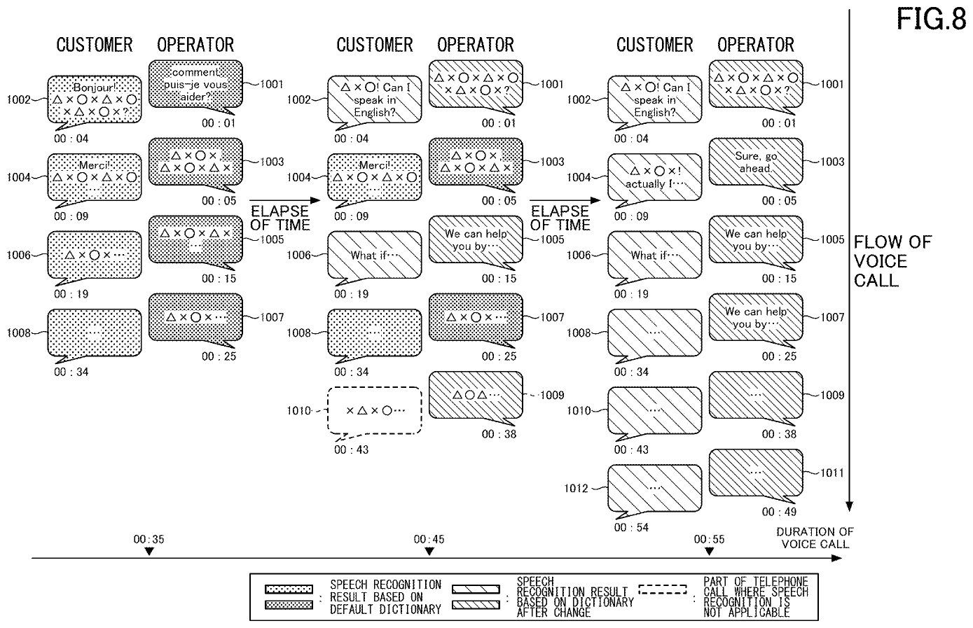

As shown in FIG. 8, assume that the speech recognition text of the voices 1001 to 1008 is obtained by the time “00:35” during the voice call, by speech recognition using the default dictionary 500. Note that the voices 1001, 1003, 1005 and 1007 are uttered by the operator, and the voices 1002, 1004, 1006, and 1008 are uttered by the customer.

In this case, assume that the currently-selected dictionary 500 is changed at or after “00:35,” and before “00:38,” during the voice call. In this case, according to this example of speech recognition, using the post-change dictionary 500, the voices 1001 to 1008 and the voices 1009 to 1012 that have been speech-recognized earlier are subjected to speech recognition again, in parallel, and the voices 1001 to 1008 are also subjected to speech recognition in parallel. That is, past voices and real-time voices are subjected to speech recognition in parallel, and the past voices themselves are also subjected to speech recognition in parallel.

In the example shown in FIG. 8, the speech recognition text for the voices 1001 and 1002, the voices 1005 and 1006, and the voice 1009 is obtained by the time “00:45” during the voice call by speech recognition using the post-change dictionary 500. In this example, the number of units to be processed in parallel is 3. This is a case where past voices and real-time voices are subjected to speech recognition in parallel, and where the voices 1001 and 1002 and the voices 1005 and 1006 among the past voices are subjected to speech recognition in parallel. Also, as for the voices 1001 to 1012, the speech recognition text is obtained by the time “00:55” during the voice call, by speech recognition using the post-change dictionary 500.

In this way, when the currently-selected dictionary 500 is changed, according to this example of speech recognition, the dictionary 500 after change of the dictionary 500 is used to process the voices uttered before the change of the dictionary 500 and the voices uttered after the change of the dictionary 500 are subjected to speech recognition in parallel, and speech recognition is also performed on the voices uttered before the change of the dictionary 500, in parallel. This makes it possible, for example, to execute speech recognition on real-time voices while simultaneously processing past voices. Also, for example, past voices can be prioritized and subjected to speech recognition. Furthermore, since past voices are subjected to speech recognition in parallel, it is possible to complete speech recognition of past voices fast.

### Details of the Service Assisting Screen in Step S107 of FIG. 3

The service assisting screen in step S107 of FIG. 3 will be described in detail below. In step S107 of FIG. 3, either the first example service assisting screen or the second example service assisting g screen shown below is displayed on the user terminal 20 as a service assisting screen.

### First Example Service Assisting Screen

In the first example service assisting screen, the display always shows the speech recognition text of the latest real-time voice. In this case, past voices' speech recognition text is visualized in the background.

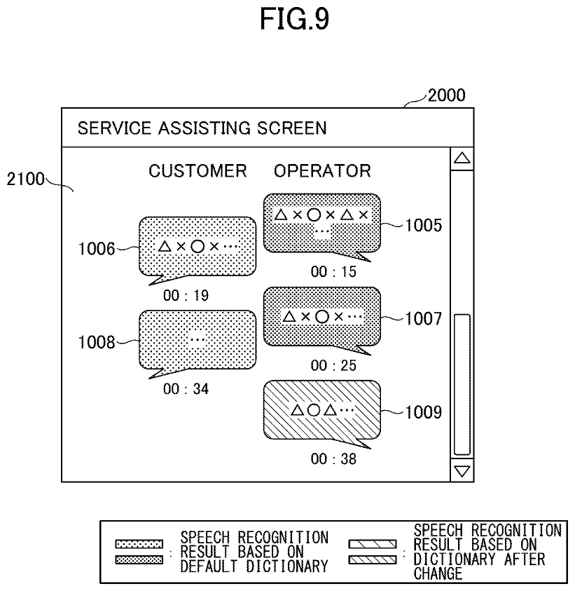

FIG. 9 shows a service assisting screen when speech recognition is executed according to the fourth example of speech recognition or the fifth example of speech recognition described above. As shown in FIG. 9, the voice display part 2100 of the service assisting screen 2000 always displays the speech recognition text of the latest real-time voice (in the example shown in FIG. 9, the voice 1009). Note that, when a new real-time voice is uttered, the voice display part 2100 is automatically scrolled, so that the speech recognition text of that real-time voice is displayed. Meanwhile, the speech recognition text of past voices is visualized in the background (that is, in the hidden part of the voice display part 2100).

This first example service assisting screen is preferably used in, for example, the first example of speech recognition, the fourth example of speech recognition, or the fifth example of speech recognition.

### Second Example Service Assisting Screen

In the second example service assisting screen, the screen is divided into two parts. One screen always displays the speech recognition text of the latest real-time voice, and the other screen displays the speech recognition text of past voices.

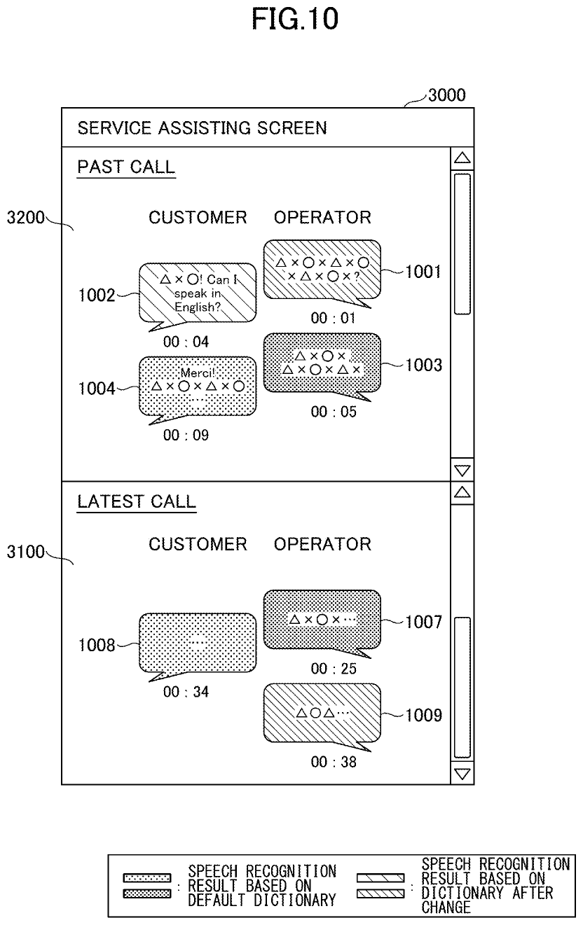

For example, FIG. 10 shows the service assisting screen when speech recognition is executed according to the fourth example of speech recognition or the fifth example of speech recognition. As shown in FIG. 10, a first voice display part 3100 of the service assisting screen 3000 always displays the speech recognition text of the latest real-time voice, and a second voice display part 3200 displays the speech recognition text of past voices (in the example shown in FIG. 10, the voice 1009). Note that, when a new real-time voice is uttered, the first voice display part 3100 is automatically scrolled so that the speech recognition text of that real-time voice is displayed. Meanwhile, the speech recognition text of past voices is displayed in the second voice display part 3200 (this not only includes speech recognition text produced from speech recognition using the post-change dictionary 500, but also includes speech recognition text not yet subjected to speech recognition using the dictionary 500 after the change).

This second example service assisting screen may be used in any of the examples of speech recognition, for example, any of the first example of speech recognition to the fifth example of speech recognition.

Note that, as for the speech recognition text of past voices displayed in second voice display part 3200, the latest speech recognition text among the speech recognition text derived from speech recognition using, for example, the post-change dictionary 500, may be displayed. Also, for example, if speech recognition for the past voices using the post-change dictionary 500 is completed, only the first voice display part 3100 may be displayed (that is, the second voice display part 3200 may be hidden once speech recognition for the past voices using the post-change dictionary 500 is completed).

### Summary

As described above, in the contact center system 1 according to an embodiment of the present disclosure, when the speech recognition dictionary 500 for use in speech recognition for the voices uttered during a voice call between an operator and a customer is changed, the voices uttered before the change of the dictionary are subjected to speech recognition again, using the post-change speech recognition dictionary 500. This makes it possible to subject the entire voice call to speech recognition using an appropriate speech recognition dictionary 500, even if the speech recognition dictionary 500 selected at the beginning of the voice call is not an appropriate one. This makes it possible to obtain accurate outcomes using speech recognition. As a result of this, it is possible to, for example, improve the quality of service and the accuracy of various analyses.

### Others: Supplementary Information

According to the second to fifth examples of speech recognition described above, if the currently-selected dictionary 500 is changed, speech recognition for past voices is performed again; consequently, if the time until the end of the voice call is short, speech recognition may not be completed in time. Therefore, in this case, speech recognition continues even after the voice call ends. This allows all the voices contained in the entire voice call to be subjected to speech recognition using an appropriate speech recognition dictionary 500.

When the currently-selected dictionary 500 is changed, which of the above second example of speech recognition to the fifth example of speech recognition is used for speech recognition then may be determined in advance using a fixed value, or may be set such that the user (administrator, supervisor, operator, etc.) can re-configure the setting. In other words, when the currently-selected dictionary 500 is changed, whether or not to process past voice files in parallel on a per voiced segment basis, and whether or not to process past voice files and real-time voice files in parallel may be set in advance as a fixed setting, or may be set such that the user can re-configure the setting.

### Alternatives

Below, several alternatives to this embodiment will be described.

### Alternative 1

According to the above embodiment, when the speech recognition dictionary 500 is changed, the voices uttered before the speech recognition dictionary 500 is changed (past voices) are subjected to speech recognition again, using the post-change speech recognition dictionary 500. Depending on the relationship between the speech recognition dictionary 500 before change of the dictionary 500 and the speech recognition dictionary 500 after change of the dictionary 500, it may not be necessary to subject the past voices to speech recognition again.

For example, if the speech recognition dictionary 500 before change of the dictionary 500 is a “speech recognition dictionary 500 specialized for financial services” and the speech recognition dictionary 500 after change of the dictionary 500 is a “speech recognition dictionary 500 specialized for insurance services,” it may not be necessary to subject the past voices to speech recognition again. This is because it is likely that a question about a financial matter was answered and then a question about insurance was answered in one call and that the operator selected an speech recognition dictionary 500 appropriate that is suitable for answering both questions.

Unlike this, if the speech recognition dictionary 500 before change of the dictionary 500 is a “general-purpose speech recognition dictionary 500” and the speech recognition dictionary 500 after change of the dictionary 500 is a “speech recognition dictionary 500 specialized for a specific task,” the past voices are subjected to speech recognition again. This is because, although the operator was unable to select an appropriate speech recognition dictionary 500 at the beginning of the call, the operator selected the general-purpose speech recognition dictionary 500 as the default dictionary 500 and subsequently selected an appropriate speech recognition dictionary 500.

In addition to the above examples, for example, depending on the content or subject matter of a question, the product or technology that is dealt with in a question, and so forth, it may not be necessary to subject past voices to speech recognition again. Examples of such cases include: when the product being the subject matter of a question continues to relate to the same type of insurance; when the subject matter of a question shifts from financial products in general to insurance; when the content of a question continues to relate to a technology or product of the same field; when the language, vocabulary, and so forth used in the speech recognition dictionary 500 before change of the dictionary 500 corresponds or contains a new language, new vocabulary, and so forth. In cases like these, it is not necessary to execute speech recognition again using the speech recognition dictionary 500 after change of the dictionary 500. Also, when it is possible to assume, from speech recognition outcomes that share something in common or are similar, or when it is possible to determine, from the speech recognition dictionary or its properties that both the pre-change speech recognition dictionary 500 and the post-change speech recognition dictionary 500 are suitable to handle the question, it is not necessary to execute speech recognition again using the post-change speech recognition dictionary 500.

### Alternative 2

According to the above embodiment, when the speech recognition dictionary 500 is changed, the past voices of both the operator and the customer may be subjected to speech recognition again using the post-change speech recognition dictionary 500, or only the voices of one party (the customer's past voices alone or the operator's past voices alone) may be subjected to speech recognition again. For example, if a customer speaks a dialect, only the customer's speech recognition dictionary 500 may be changed according to the dialect the customer speaks, and then the customer's voice may be subjected to speech recognition again. By allowing the operator and customer, for example, to have respective speech recognition dictionaries 500 in this way, objects that are subjected to speech recognition again can be limited, thereby reducing the burden of repeating speech recognition.

### Alternative 3

The above embodiment assumed that the customers and all operators shared in common the same speech recognition dictionary 500, but this is by no means a limitation. The speech recognition dictionary 500 that an operator can select may vary depending on, for example, the operator's personal voice characteristics, field of work, etc. That is, each operator may be able to select a speech recognition dictionary 500 that suits, for example, his or her voice characteristics and field of work. Also, the operator's speech recognition dictionary 500 may be selected by taking into account its suitability to the customer. For example, if a customer speaks a dialect and the operator also speaks the dialect to accommodate the customer, the operator's speech recognition dictionary 500 may be changed from a dictionary that supports only standard Japanese to a speech recognition dictionary 500 that supports both the customer's dialect and standard Japanese. In this case, it is sufficient to repeat speech recognition only on the past voices of the operator whose speech recognition dictionary 500 has been changed. If it is clear from the properties of the speech recognition dictionary that the post-change speech recognition dictionary 500 can handle both the customer's dialect and the operator's standard Japanese, as described above, there is no need to execute speech recognition again.

The present invention is not limited to the above-described embodiment specifically disclosed, and various modifications, alterations, combinations with existing technologies, etc. are possible without departing from the scope of the claims.

### EXPLANATION OF SYMBOLS

1 Contact center system
10 Speech recognition system
20 User terminal
30 Telephone machine
40 PBX
50 Network switch
60 Customer terminal
70 Communication Network
101 Voice recording part
102 Dictionary selection part
103 Speech recognition part
104 UI providing part
105 Voice storage part
106 Dictionary storage part
107 Voice call history storage part
201 UI control part
E Contact center environment

1-12. (canceled)

13. An information processing system comprising:
a processor; and
a memory storing computer-executable instructions that, when executed by the processor, cause the information processing system to at least:
select a first speech recognition dictionary for use in speech recognition from among a plurality of speech recognition dictionaries;
generate first speech recognition text by converting voices uttered during a voice call with a customer, into the first speech recognition text, by speech recognition using the first speech recognition dictionary;
select, subsequent to the selection of the first speech recognition dictionary, a second speech recognition dictionary from among the plurality of speech recognition dictionaries; and
generate a second speech recognition text using the second speech recognition dictionary by converting at least a part of the voices having been converted into the first speech recognition text using the first speech recognition dictionary.

14. The information processing system according to claim 13, wherein, when the second speech recognition dictionary is selected, the computer-executable program instructions further cause the information processing system to convert a plurality of voices, uttered before the second speech recognition dictionary is selected, into the second speech recognition text, by speech recognition using the second speech recognition dictionary, to generate the second speech recognition text.

15. The information processing system according to claim 13, wherein, when the second speech recognition dictionary is selected, the computer-executable program instructions further cause the information processing system to convert only voices uttered by the customer, into the second speech recognition text, among a plurality of voices uttered before the second speech recognition dictionary is selected, by speech recognition using the second speech recognition dictionary, to generate the second speech recognition text.

16. The information processing system according to claim 13, wherein, when the second speech recognition dictionary is selected, the computer-executable program instructions further cause the information processing system to convert voices uttered after the second speech recognition dictionary is selected, into the second speech recognition text, by speech recognition using the second speech recognition dictionary, to generate the second speech recognition text.

17. The information processing system according to claim 13, wherein the computer-executable program instructions further cause the information processing system to carry out the speech recognition only after a predetermined period of time elapses from a beginning of the voice call, and generate the speech recognition text using a predetermined speech recognition dictionary when no speech recognition dictionary is selected before the predetermined period of time elapses.

18. The information processing system according to claim 13, wherein, when the second speech recognition dictionary is selected, the computer-executable program instructions further cause the information processing system to postpone the speech recognition on voices uttered before the second speech recognition dictionary is selected, for a predetermined period of time, depending on at least one of: a language of the voice call; content of a question; a subject matter of the voice call; and a product or technology to which the voice call is directed.

19. An information processing system comprising:
a processor; and
a memory storing computer-executable instructions that, when executed by the processor, cause the information processing system to at least:
select a first speech recognition dictionary for use in speech recognition from among a plurality of speech recognition dictionaries;
generate first speech recognition text by converting voices uttered during a voice call with a customer, into the first speech recognition text, by speech recognition using the first speech recognition dictionary;
display the first speech recognition text on a screen;
select, subsequent to the selection of the first speech recognition dictionary, a second speech recognition dictionary, from among the plurality of speech recognition dictionaries;
generate second speech recognition text by converting voices uttered before the second speech recognition dictionary is selected and voices uttered after the second speech recognition dictionary is selected, among the voices uttered during the voice call with the customer, into the second speech recognition text, by speech recognition using the second speech recognition dictionary; and
display the second speech recognition text on the screen.

20. The information processing system according to claim 19, wherein, when the second speech recognition dictionary is selected, the computer-executable program instructions further cause the information processing system to at least:
divide the screen into a first screen and a second screen;
display, on the first screen, the second speech recognition text obtained by converting the voices uttered after the second speech recognition dictionary is selected, into the second speech recognition text, by the speech recognition using the second speech recognition dictionary; and
display, on the second screen, the first speech recognition text or the second speech recognition text obtained by converting the voices uttered before the second speech recognition dictionary is selected, into the second speech recognition text, by the speech recognition using the second speech recognition dictionary.

21. The information processing system according to claim 20, wherein, when the second speech recognition dictionary is selected, the computer-executable program instructions further cause the information processing system to display, on the first screen, the second speech recognition text, obtained by converting a latest voice uttered after the second speech recognition dictionary is selected, by the speech recognition using the second speech recognition dictionary.

22. The information processing system according to claim 20, wherein, when the second speech recognition dictionary is selected, the computer-executable program instructions further cause the computer system to hide the second screen when the speech recognition is completed for the voices uttered before the second speech recognition dictionary is selected.

23. An information processing method for causing a computer to perform steps including:
selecting a first speech recognition dictionary for use in speech recognition from among a plurality of speech recognition dictionaries;
generating first speech recognition text by converting voices uttered during a voice call with a customer, into the first speech recognition text, by speech recognition using the first speech recognition dictionary; and
generating, upon a switchover from the first speech recognition dictionary to a second speech recognition dictionary, second speech recognition text by converting voices uttered before the switchover is made, among the voices uttered during the voice call with the customer, into the second speech recognition text, by speech recognition using the second speech recognition dictionary.

24. A non-transitory computer-readable recording medium storing a program that, when executed by a computer, causes the computer to at least:
select a first speech recognition dictionary for use in speech recognition from among a plurality of speech recognition dictionaries;
generate speech recognition text by converting voices uttered during a voice call with a customer, into text, by speech recognition using the first speech recognition dictionary; and
generate, upon a switchover from the first speech recognition dictionary to a second speech recognition dictionary, second speech recognition text by converting voices uttered before the switchover is made, among the voices uttered during the voice call with the customer, into the second speech recognition text, by speech recognition using the second speech recognition dictionary.
